(19) United States
(12) Patent Application Publication
(10) Pub. No.: US 2006/0228964 A1
(43) Pub. Date: Oct. 12, 2006

(54) FABRIC TREATED WITH DURABLE STAIN REPEL AND STAIN RELEASE FINISH AND METHOD OF INDUSTRIAL LAUNDERING TO MAINTAIN DURABILITY OF FINISH

(75) Inventors: MICHELLE H. WATKINS, Fishersville, VA (US); Carmen A. Covelli, Chadds Ford, PA (US); Leonard Ray Seals, Greensboro, NC (US)

Correspondence Address: INVISTA NORTH AMERICA S.A.R.L., THREE LITTLE FALLS CENTRE/1052, 2801 CENTERVILLE ROAD, WILMINGTON, DE, 19808, US

(73) Assignees: INVISTA North America S.a r.l., Wilmington, DE (US); Ciba Specialty Chemicals Corporation, High Point, NC (US)

(21) Appl. No.: 11/279,272

(22) Filed: Apr. 11, 2006

Related U.S. Application Data
(60) Provisional application No. 60/670,403, filed on Apr. 12, 2005.

(51) Int. Cl. D06F 35/00; D06F 39/00; B32B 27/04; B32B 27/12; B32B 5/02

(52) U.S. Cl. 442/94; 8/158; 8/159; 427/421.1; 427/430.1; 427/429; 427/372.2; 442/93; 442/91; 442/164; 442/199

(57) ABSTRACT

The invention provides a fabric comprising one or more polyesters optionally with other fibers which is treated with a finish comprising at least one fluorochemical stain repellent agent and at least one fluorochemical stain release agent, wherein the fabric maintains oil repellency and stain release capability after at least five industrial launderings at about 55° C. to about 65° C. The invention also provides a method of treating a fabric with a finish to impart oil repellency, water repellency, and stain release which is durable to repeated industrial laundering. The invention further provides textile articles comprising the treated fabric, and a method for industrial laundering of such treated fabric and textile articles.

### CROSS-REFERENCE TO RELATED APPLICATION

This application is a non-provisional utility application filing claiming priority from U.S. Provisional Ser. No. 60/670,403, filed Apr. 12, 2005.

### FIELD OF THE INVENTION

This invention relates to a fabric which has been treated with a fluorochemical finish and which maintains durability of the finish through repeated industrial laundering. The fluorochemical finish imparts stain repellency, water repellency, and stain release to the fabric. This invention also relates to a method of applying a fluorochemical finish which is durable to industrial laundering to a fabric. The invention relates as well to textile articles comprising fabrics treated with the durable fluorochemical finish. This invention further relates to a method for industrial laundering of fabric treated with the fluorochemical finish, or textile articles comprising the treated fabric, in such a way that the durability of the fluorochemical finish is maintained.

### BACKGROUND OF THE INVENTION

Fluorochemical finishes useful as fabric treatments or fabric protectors are generally known. Such fluorochemical finishes are used to keep items of apparel or other textile articles looking newer longer and to protect them from permanent damage due to staining. One major class of fluorochemical finishes is known as stain repellent technology, in which the finish acts as a stain repellency barrier that prevents most spills from becoming stains in the first place. Stain repellency is also referred to as oil repellency. The use of stain repellent technology is disclosed, for example, in U.S. Pat. No. 6,825,138. A second major class of fluorochemical finishes is known as stain release technology, in which a stain release system combines with detergents in the laundry process to remove any ground-in dirt or residual staining. The use of stain release technology is disclosed, for example, in U.S. Pat. No. 5,467,512.

Fluorochemical finishes which combine more than one technology in a single formulation have been disclosed. For example, a process for imparting durable water and oil repellency and durable soil release characteristics is disclosed in U.S. Pat. No. 6,818,253. Wash-durable fluorochemical-based treatments that impart both soil resistance and moisture wicking characteristics are disclosed in U.S. Patent Application 2004/0224587. However, fluorochemical finishes and the fabrics treated with them are generally not durable to industrial laundering. Fabrics and textile articles which undergo repeated industrial laundering and yet which maintain acceptable stain repellency, water repellency, and stain release through improved durability of the fluorochemical finish providing such desirable characteristics are sought. Industrial laundering methods for fabrics and textile articles which promote durability of the stain repellent, water repellent, and stain release finish applied to the fabrics and textile articles are also sought.

### SUMMARY OF THE INVENTION

The present invention in a first aspect provides a fabric comprising polyester, wherein the fabric is treated with a finish comprising at least one fluorochemical stain repellent agent and at least one fluorochemical stain release agent, wherein the fabric has an oil repellency rating of at least 3 (as measured by AATCC Test Method 118-2002) and a stain release rating of at least 3 (as measured by AATCC Test Method 130-2000) after at least five industrial launderings at about 55° C. to about 65° C.

The present invention in a second aspect also provides a method of treating a fabric with a finish to impart oil repellency, water repellency, and stain release which are durable to repeated industrial laundering, the method comprising the steps of:
a) providing a fabric comprising polyester;
b) applying a finish comprising at least one fluorinated polyurethane stain repellent agent, and at least one fluorinated substituted urethane stain release agent, wherein the ratio of the percent on weight of fabric of the at least one fluorinated polyurethane to the percent on weight of fabric of the at least one fluorinated substituted urethane is from about 0.2 to about 3.0; and
c) drying the fabric from about 160° C. to about 200° C.
   In addition, the present invention provides a textile article comprising the treated fabric.

The present invention also provides a method for industrial laundering of a fabric or a textile article comprising the fabric, the fabric being treated with a finish comprising at least one fluorochemical stain repellent agent and at least one fluorochemical stain release agent to impart oil repellency and stain release characteristics, the method comprising the steps of:
a) providing a treated fabric or a textile article comprising the treated fabric;
b) washing the fabric or the textile article in water containing a detergent and optionally chlorine bleach at about 55° C. to about 65° C.;
c) separating the wash water from the fabric or textile article;
d) rinsing the fabric or the textile article;
e) separating the rinse water from the fabric or textile article; and
f) drying the fabric or textile article to provide dry fabric or dry textile article having an oil repellency rating of at least 3 as measured by AATCC Test Method 118-2002 and a stain release rating of at least 3 as measured by AATCC Test Method 130-2000.

The present invention also provides a method for industrial laundering of a fabric or a textile article comprising the fabric, the fabric being treated with a finish comprising at least one fluorinated polyurethane and at least one fluorinated substituted urethane to impart oil repellency and stain release characteristics, the method comprising the steps of:
a) providing a treated fabric or a textile article comprising the treated fabric;
b) washing the fabric or the textile article in water containing a detergent and optionally chlorine bleach at about 55° C. to about 65° C.;
c) separating the wash water from the fabric or textile article;
d) rinsing the fabric or the textile article;
e) separating the rinse water from the fabric or textile article; and
f) drying the fabric or textile article to provide dry fabric or dry textile article having an oil repellency rating of at least 3 as measured by AATCC Test Method 118-2002 and a stain release rating of at least 3 as measured by AATCC Test Method 130-2000.

### DETAILED DESCRIPTION OF THE INVENTION

It has now been found that fabrics which have been treated with fluorochemical finishes comprising at least one fluorochemical stain repellent agent and at least one fluorochemical stain release agent, and textile articles comprising such fabrics, maintain good performance for oil repellency, water repellency, and stain release even with repeated industrial laundering at about 131-149° F. (about 55-65° C.), for example about 140-149° F. (about 60-65° C.). The at least one fluorochemical stain repellent agent may be, for example, at least one fluorinated polyurethane, and the at least one fluorochemical stain release agent may be, for example, at least one fluorinated substituted urethane. The industrial laundering can be repeated a number of times, for example at least 5, or at least 30, or at least 40, or at least 50. The durability of the fluorochemical finish is maintained, as evidenced by the fabric or textile article having an oil repellency rating of at least 3, a water repellency rating of at least 3, and a stain release rating of at least 3 (measured as described in the Test Methods section) after industrial laundering. The durability of the stain repellent, water repellent, and stain release finish after repeated industrial laundering is surprisingly good and a significant improvement over other fluorochemical finishes. Laundering that results in deposits on a fabric or textile article surface may hinder performance.

As used herein, the phrase “at least one” means one or more.

As used herein, the term “fluorochemical” means a polymeric material containing at least one fluorinated segment. The terms “fluorochemical,” “fluoropolymer,” and “fluorocarbon” are used interchangeably herein.

The terms “oil repellency” and “stain repellency” are used interchangeably herein to mean the ability of a substrate to block oil from penetrating into the substrate. Oil penetration into the substrate is said to stain the substrate. Similarly, the term “water repellency” is used herein to mean the ability of a substrate to block water from penetrating into the substrate. Stain repellent and water repellent agents lower the critical surface tension of the substrate so that oil and water bead up and roll off the substrate rather than penetrating into it.

As used herein, the term “stain release” refers to the extent to which a stained substrate regains its original unstained appearance. Generally, a stain release agent has a lower level of repellency than a stain or oil repellent agent and may allow for the stain or oil to penetrate the substrate. The stain release agent allows the stain to be at least partially removed upon laundering or other cleaning procedures. The terms “stain release” and “soil release” are used interchangeably herein.

As used herein, the term “durable” means the characteristic of maintaining an acceptable level of performance over an extended number of industrial laundering cycles without significant deterioration. As used herein, “durability” of the stain repellent and stain release finish refers to the ability of the finish to continue to provide an acceptable level of stain repellency, water repellency, and stain release performance to the treated substrate after repeated industrial laundering. Acceptable levels of stain repellency, water repellency, and stain release performance are considered to be ratings of at least “3” by the methods described in the Test Methods section.

As used herein, the term “textile article” means an article comprising knit, woven, or nonwoven fabric. “Textile article” includes, for example, a garment or article of clothing such as a shirt, pants, jacket, work shirt, work pants, uniform, jumpsuit, smock, hat, gloves, outerwear, sportswear, chef coat, chef apron, and chef hat. “Textile article” also includes such items as sheets, pillowcases, bedspreads, quilts, blankets, comforters, comforter covers, sleeping bags, shower curtains, curtains, drapes, tablecloths, napkins, wiping cloths, dish towels, and protective coverings for upholstery or furniture.

As used herein, the term “laundering” means the combination of at least one washing cycle followed by one drying cycle, optionally with a rinsing cycle interposed after the washing cycle and before the drying cycle.

As used herein, the term “industrial laundering” refers to laundering processes by commercial industrial laundries which typically utilize washing temperatures of about 140-185° F. (60-85° C.) and drying temperatures of about 165-300° F. (74-149° C.), along with strong detergent formulas which may include chlorine bleach and highly alkaline chemicals. The typical processing pH range is 9.0-12.5 and load size may be 25-1000 tbs. Industrial laundering is typically performed on rental uniforms or other articles of work apparel which are worn under conditions where staining with oily material may occur.

As used herein, the term “home laundering” refers to laundering performed by a consumer in the home environment. In the United States, home laundering typically utilizes washing temperatures of 100-120° F. (38-49° C.) and drying temperatures of 120-160° F. (49-71° C.). The normal processing pH range is 9.0-10.0 and load size is typically 4-8 lbs. Home laundering conditions typically are milder and often more infrequent than those encountered for fabrics and textile articles subjected to industrial laundering. Home laundering conditions may be expected to prolong the life expectancy of a textile article. For both industrial and home laundering, lower temperatures, lower pH levels, and fewer launderings may extend the life expectancy of a textile article.

It is often desirable for a fabric or textile article to exhibit stain or water repellency, as well as stain release, in order for the fabric or textile article to look clean and new for as long a time as possible. The characteristics of stain repellency, water repellency, and stain release are especially important for fabrics or textile articles which are used in environments where staining can occur easily and repeatedly, such as in work environments where automotive or machinery repair is performed, or where food is prepared, for example. In these types of work environments, garments such as uniforms, jumpsuits, smocks, work shirts, work pants, chef jackets, chef aprons, or chef hats, for example, are often worn. These garments typically undergo repeated industrial laundering. It is thus desirable for a garment, fabric, or textile article used in such environments to have a stain repellent, water repellent, and stain release finish which is durable to repeated industrial laundering as this extends the useful life of the item. This is especially true for fabric or textile articles in the rental market, which are industrially laundered on a repeated basis.

One embodiment of the invention is a fabric comprising polyester, wherein the fabric is treated with a finish comprising at least one fluorochemical stain repellent agent and at least one fluorochemical stain release agent, wherein the fabric has an oil repellency rating of at least 3 as measured by AATCC Test Method 118-2002 and a stain release rating of at least 3 as measured by AATCC Test Method 130-2000 after at least five, for example after at least 30 or after at least 40, or after at least 50 industrial launderings at about 131° F. to about 149° F. (about 55° C. to about 65° C.), for example at about 140° F. to about 149° F. (about 60° C. to about 65° C.). Additionally, the fabric may have a water repellency rating of at least 3 as measured by the Water Drop Test Method. The fabric may be of nonwoven, knit, or woven construction.

Another embodiment of the invention is a textile article comprising the fabric which has been treated with the fluorochemical finish to provide the characteristics described above.

As used herein, the term “polyester” means polyethylene terephthalate, polytrimethylene terephthalate, and polybutylene terephthalate, and includes “copolyester” within its meaning. The polyester may be monocomponent fiber or bicomponent fiber. The polyester may be staple fiber or continuous filament. The fabric comprising polyester, or a textile article which comprises the fabric, such as a uniform, for example, may include other fibers, for example blends of cotton, wool, rayon, polyamide, acrylic, acetate, spandex, Nomex®, Kevlar®, or other fibers, as well as blends of two or more polyesters of different compositions, and such blends in combination with any of the other fibers listed above. The fabric may contain from about 5 weight percent (wt %) to about 100 weight percent polyester, based on the total weight of the fabric. In the case where the fabric further comprises cotton or another fiber or combination of fibers, the fabric may comprise from about 5 wt % to about 95 wt % polyester, based on total weight of fabric.

As used herein, “bicomponent fiber” means a fiber in which two polymers of the same general class are intimately adhered to each other along the length of the fiber, so that the fiber cross-section is for example a side-by-side, eccentric sheath-core, or other suitable cross-section from which useful crimp can be developed.

As used herein, the term “side-by-side” means that the two components of the bicomponent fiber are immediately adjacent to one another and that no more than a minor portion of either component is within a concave portion of the other component. “Eccentric sheath-core” means that one of the two components completely surrounds the other component but that the two components are not coaxial.

The polyester bicomponent fiber comprises poly(trimethylene terephthalate) and at least one polymer selected from the group consisting of poly(ethylene terephthalate), poly(trimethylene terephthalate), and poly(tetramethylene terephthalate) or a combination of such members, in a weight ratio of from about 30:70 to about 70:30 and has an after heat-set crimp contraction value of at least about 10%, for example at least about 35% and at most about 80%. The polymers may be, for example, poly(ethylene terephthalate) and poly(trimethylene terephthalate), poly(trimethylene terephthalate) and poly(tetramethylene terephthalate), or poly(trimethylene terephthalate) and poly(trimethylene) terephthalate, for example of different intrinsic viscosities, although different combinations are also possible. Alternatively, the compositions can be similar, for example a poly(trimethylene terephthalate) homopolyester and a poly(trimethylene terephthalate) copolyester, optionally also of different viscosities. Other polyester bicomponent combinations are also possible, such as poly(ethylene terephthalate) and poly(tetramethylene terephthalate), or a combination of poly(ethylene terephthalate) and poly(ethylene terephthalate), for example of different intrinsic viscosities, or a poly(ethylene terephthalate) homopolyester and a poly(ethylene terephthalate) copolyester.

The polyester, whether monocomponent or bicomponent, can be one or more copolyesters, and “poly(ethylene terephthalate),” “poly(tetramethylene terephthalate)”, and “poly(trimethylene terephthalate)” include such copolyesters within their meanings. For example, a copoly(ethylene terephthalate) can be used in which the comonomer used to make the copolyester is selected from the group consisting of linear, cyclic, and branched aliphatic dicarboxylic acids (and their diesters) having 4-12 carbon atoms (for example butanedioic acid, pentanedioic acid, hexanedioic acid, dodecanedioic acid, and 1,4-cyclo-hexanedicarboxylic acid); aromatic dicarboxylic acids (and their diesters) other than terephthalic acid and having 8-12 carbon atoms (for example isophthalic acid and 2,6-naphthalenedicarboxylic acid); linear, cyclic, and branched aliphatic diols having 3-8 carbon atoms (for example 1,3-propanediol, 1,2-propanediol, 1,4-butanediol, 3-methyl-1,5-pentanediol, 2,2-dimethyl-1,3-propanediol, 2-methyl-1,3-propanediol, and 1,4-cyclohexanediol); and aliphatic and araliphatic ether glycols having 4-10 carbon atoms (for example, hydroquinone bis(2-hydroxyethyl)ether, or a poly(ethyleneether)glycol having a molecular weight below about 460, including diethyleneether glycol). The comonomer can be present to the extent that it does not compromise the benefits of the invention, for example at levels of about 0.5-15 mole percent based on total polymer ingredients. Isophthalic acid, pentanedioic acid, hexanedioic acid, 1,3-propane diol, and 1,4-butanediol are exemplary comonomers.

The copolyester(s) can also be made with minor amounts of other comonomers, provided such comonomers do not have an adverse effect on the physical properties of the fiber. Such other comonomers include 5-sodium-sulfoisophthalate, the sodium salt of 3-(2-sulfoethyl)hexanedioic acid, and dialkyl esters thereof which can be incorporated at about 0.2-5 mole percent based on total polyester. For improved acid dyeability, the (co)polyester(s) can also be mixed with polymeric secondary amine additives, for example poly(6,6′-imino-bishexamethylene terephthalamide) and copolyamides thereof with hexamethylenediamine, preferably phosphoric acid and phosphorous acid salts thereof. Small amounts, for example about 1 to 6 milliequivalents per kg of polymer, of tri- or tetra-functional comonomers, for example trimellitic acid (including precursors thereto) or pentaerythritol, can be incorporated for viscosity control.

The polyester, whether monocomponent or bicomponent, can also comprise an effective amount of conventional additives such as antistats, antioxidants, antimicrobials, flameproofing agents, lubricants, dyestuffs, light stabilizers, optical brighteners, and delustrants such as titanium dioxide, provided the additives do not detract from the beneficial aspects of the invention.

The fabric comprising polyester is treated with a fluorochemical finish comprising at least one fluorochemical stain repellent agent and at least one fluorochemical stain release agent to impart oil repellency, water repellency, and stain release which are durable to repeated industrial laundering, for example at least 5 industrial launderings. Fluorochemical polymers which may be used to formulate the fluorochemical finish include fluorine-containing urethanes. Optionally, these may be combined with other fluorochemicals, such as mixtures of polyesters based on carboxylic acids and alcohols which contain perfluoroalkyl radicals. The at least one fluorochemical stain repellent agent comprises at least one fluorinated polyurethane, for example such as contained in Zonyl® 7713 (available from Ciba Specialty Chemicals or E.I. du Pont de Nemours). The at least one fluorochemical stain release agent comprises at least one fluorinated substituted urethane, for example such as contained in Zonyl® 7910, (available from E.I. du Pont de Nemours). The ratio of the percent on weight of fabric (% owf) of the at least one fluorinated polyurethane to the percent on weight of fabric of the at least one fluorinated substituted urethane is from about 0.2 to about 3.0, for example from about 0.6 to about 1.4, or from about 0.6 to about 1.2. The % owf values are calculated from the amounts of stain repellent and stain release agents in the finish. For example, if the stain repellent agent is applied at 40 g/l, or approximately 4 percent by weight, and the stain release agent is applied at 50 g/l, or approximately 5 percent by weight, then the ratio of the stain repellent agent to the stain release agent would be 0.8. Other fluorochemical polymers or compounds which provide adequate levels of oil repellency, water repellency, and stain release to the treated fabric may also be used, optionally in conjunction with the fluorine-containing polyurethanes.

The finish optionally may comprise components in addition to the at least one fluorochemical stain repellent agent and the at least one fluorochemical stain release agent. For example, at least one extender is often used with a fluorochemical. “Extender” is a term of art for a non-fluorinated substance, used in combination with the fluorochemical, that has water-repellent properties of its own and is typically a low-melting, substantially water-insoluble material such as a mineral wax or a synthetic organic polymeric material such as a low molecular weight polyethylene, a polyisocyanate, fluorine-free acrylic polymers (including polyacrylates, polymethacrylates, and polyacrylonitriles), a polysiloxane, or other relatively hydrophobic polymers that are generally available in latex form, such as poly-diene homopolymers and heteropolymers. Extenders are typically used to increase the efficiency of low loadings of a fluoropolymer since the extender is less expensive than the fluoropolymer.

Optionally, the finish also may comprise agents to provide a wrinkle free finish (also known as “Easy Care,” “Durable Press,”, “Wrinkle-Resistant,” or “No-Iron” finish) to the fabric. Cross-linking agents such as dimethyloldihydroxyethyleneurea (DMDHEU), modified dimethyloldihydroxyethyleneurea, or other aminoplast resins may be used with a parabolic catalyst such as inorganic magnesium salts or aluminum chloride. Melamine resins may be used, optionally with alkaline zinc salts. Urea-formaldehyde resins of the etherified and carbamide types may also be employed, as well as polysiloxane or silicone emulsions. Other polymers or compounds which provide adequate levels of crosslinking may also be used.

Another embodiment of the invention is a method for treating a fabric with a finish to impart oil repellency, water repellency, and stain release which are durable to repeated industrial laundering, the method comprising the steps of:
a) providing a fabric comprising one or more polyesters or one or more polyesters blended with another fiber or combination of fibers;
b) applying a finish comprising at least one fluorochemical stain repellent agent and at least one fluorochemical stain release agent, wherein the ratio of the percent on weight of fabric of the at least one fluorochemical stain repellent agent to the percent on weight of fabric of the at least one fluorochemical stain release agent is from about 0.2 to about 3.0; and
c) drying the treated fabric from about 160° C. to about 200° C.
   The ratio of the percent on weight of fabric of the at least one fluorochemical stain repellent agent to the percent on weight of fabric of the at least one fluorochemical stain release agent may also be, for example, from about 0.6 to about 1.4, or from about 0.6 to about 1.2. The optimum ratio for a fabric or textile article can vary depending on the fabric weight, fabric construction and fabric preparation through wet processing. Typically, the fabric with applied finish is dried for about 1 to about 2 minutes.

Yet another embodiment of the invention is a method for treating a fabric with a finish to impart oil repellency, water repellency, and stain release which are durable to repeated industrial laundering, the method comprising the steps of:
a) providing a fabric comprising one or more polyesters or one or more polyesters blended with another fiber or combination of fibers;
b) applying a finish comprising at least one fluorinated polyurethane stain repellent agent and at least one fluorinated substituted urethane stain release agent, wherein the ratio of the percent on weight of fabric of the at least one fluorinated polyurethane stain repellent agent to the percent on weight of fabric of the at least one fluorinated substituted urethane stain release agent is from about 0.2 to about 3.0; and
c) drying the treated fabric from about 160° C. to about 200° C.
   The ratio of the percent on weight of fabric of the at least one fluorochemical stain repellent agent to the percent on weight of fabric of the at least one fluorochemical stain release agent may also be, for example, from about 0.6 to about 1.4, or from about 0.6 to about 1.2. The optimum ratio for a fabric or textile article can vary depending on the fabric weight, fabric construction and fabric preparation through wet processing. Typically, the fabric with applied finish is dried for about 1 to about 2 minutes.

The fabric is treated with the fluorochemical finish in a manner which permits application of a controlled amount of finish. The finish may be applied by, for example, padding, coating, impregnating, immersing, spraying, brushing, and film-coating, or a combination of such application methods. Padding refers to applying a liquid coating by passing the fabric through a bath and subsequently through squeeze rollers. After treatment with the finish, the fabric is then heated at from about 160° C. to about 200° C., usually for about 1 to about 2 minutes. The fluorochemical finish may be applied to the fabric as one formulation or as sequential formulations provided that the method of application does not detract from the beneficial aspects of the invention. Typically, the finish is applied to the fabric at a loading such that the total loading of the fluorochemicals is from about 7 weight percent to about 14 weight percent, for example from about 9 weight percent to about 13 weight percent, based on weight of the fabric. This loading level has been found to provide adequate and durable oil repellency, water repellency, and stain release to the fabric.

Yet another embodiment of the invention is a method for industrial laundering of a fabric, or a textile article comprising the fabric, the fabric being treated with a finish comprising at least one fluorochemical stain repellent agent and at least one fluorochemical stain release agent to impart oil repellency and stain release. The method comprises the steps described below. The durability of the fluorochemical finish on the fabric, or textile article comprising the fabric, through repeated laundering is maintained according to the method. An additional embodiment of the invention is the method as described herein, with the exception that the fabric is treated with a finish comprising at least one fluorinated polyurethane stain repellent agent and at least one fluorinated substituted urethane stain release agent. The ratio of the percent on weight of fabric of the at least one fluorinated polyurethane to the percent on weight of fabric of the at least one fluorinated substituted urethane may be from about 0.2 to about 3.0, for example from about 0.6 to about 1.4, or from about 0.6 to about 1.2. The optimum ratio for a fabric or textile article can vary depending on the fabric weight, fabric construction and fabric preparation through wet processing.

The fabric, or textile article comprising the fabric, is washed in water containing a detergent, and optionally chlorine bleach, at about 131° F. to about 149° F. (about 55° C. to about 65° C.), for example at about 140° F. to about 149° F. (about 60° C. to about 65° C.). The wash water, which contains the detergent and any removed soil, is separated from the fabric or textile article. The fabric or textile article is rinsed with water, and the rinse water is separated from the fabric or textile article. Optionally, other laundering agents may be used in the wash or rinse cycles, for example chlorine bleach or a softening agent. The fabric or textile article is then dried to produce dry fabric or a dry textile article. The fluorochemical finish is said to be durable when, after repeated industrial laundering, the fabric or textile article has an oil repellency rating and a stain release rating of at least 3 as measured by AATCC Test Method 118-2002 and AATCC Test Method 130-2000, respectively. Repeated laundering can be, for example, at least 5 launderings, or at least 30 launderings, or at least 40 launderings, or at least 50 launderings. Laundering that results in deposits on a fabric or textile article surface may hinder performance.

### Test Methods

Fabric samples were industrially laundered according to the method International Standard ISO 15797:2002(E) “Textiles—Industrial Washing and Finishing Procedures for Testing of Workwear,” Procedure 3 (Washing Procedures for White Workwear—Chlorine Bleach—Cotton) except that the wash temperature was modified to 140° F. (60° C.).

Water repellency ratings were determined according to the Water Drop Test Method described in the Invista publication “Global Specifications and Quality Control Tests for Fabrics Treated with Teflon® Fabric Protector,” which is similar to AATCC test method 193-2004. Water repellency was tested by placing drops of water-alcohol mixtures of varying surface tensions on the fabric, then visually determining the extent of surface wetting. This test provides a rough index of aqueous stain resistance. Generally, the higher the water repellency rating, the better the finished fabric's resistance to staining by water-based substances. The composition of standard test liquids is shown in Table 1.

TABLE 1
Standard Test Liquids.*

| | Composition, volume percent | | Surface Tension at 25° C. |
|---|---|---|---|
| Rating | Isopropyl Alcohol | Distilled Water | (77° F.) (dyn/cm) |
| 1 | 2 | 98 | 59 |
| 2 | 5 | 95 | 50 |
| 3 | 10 | 90 | 42 |
| 4 | 20 | 80 | 33 |
| 5 | 30 | 70 | 27.5 |
| 6 | 40 | 60 | 25.4 |

*Standard test liquids may be prepared in bulk in the laboratory by purchasing reagent grade isopropyl alcohol and distilled water and mixing according to the volume percentages listed for each rating liquid composition.

Fabric samples were placed face up on white blotting paper which rested on a flat horizontal surface. Drops of standard test liquids beginning with the test liquid having a rating of 1, were applied to the test fabric in three locations. Each drop was approximately 5 mm in diameter or 0.05 mL in volume. The drops were observed for ten seconds from an approximate angle of 45°. If at least two of the three drops were not observed to wet or penetrate the fabric and did not show wicking around the drops, the test was repeated on an adjacent site using the test liquid having a rating of 2. The procedure was continued until at least two of the three drops wet or showed wicking into the fabric within 10 seconds. The fabric's water repellency rating was determined to be the highest numbered liquid for which at least two of the three drops did not wet or wick into the fabric.

Oil repellency ratings were determined according to Standard Test Method 118-2002 of the American Association of Textile Chemists and Colorists (AATCC). Oil repellency was tested by placing drops of hydrocarbon liquids of varying surface tensions on the fabric, then visually determining the extent of surface wetting. This test determines how well finished fabrics resist oily stains and wetting by organic liquids. Generally, the higher the oil repellency rating, the better the finished fabric's resistance to staining by oily substances. The standard test liquids are listed in Table 2.

TABLE 2
Standard Oil Repellency Test Liquids

| | | Surface Tension at 25° C. |
|---|---|---|
| Rating | Hydrocarbon | (77° F.) (dyn/cm) |
| 1 | Refined Mineral Oil | 31.0 |
| 2 | Refined Mineral Oil/n-Hexadecane | 29.2 |
| | 65/35 vol % at 21° C. (70° F.) | |
| 3 | N-Hexadecane | 27.3 |
| 4 | n-Tetradecane | 26.2 |
| 5 | n-Dodecane | 24.6 |
| 6 | n-Decane | 23.6 |

Different types of wetting may be encountered, depending on the fabric's finish, fiber, or construction. With many fabrics, the endpoint rating is obvious because the fabric will completely resist wetting by one test liquid, but will allow immediate penetration by the next liquid. With some fabrics, however, endpoint determination can be difficult. These fabrics will show progressive wetting by several test liquids, as shown by a partial darkening of the fabric at the liquid/fabric interface. On black or dark fabrics, wetting can be detected by a loss of “sparkle” within the drop. For fabrics where the endpoint is difficult to determine, the endpoint is considered to be the test liquid that causes complete darkening at the interface within 30 seconds.

Fabric samples were placed face up on white blotting paper which rested on a flat horizontal surface. Drops of standard test liquid, beginning with the test liquid having a rating of 1, were applied to the test fabric in five locations. Each drop was approximately 5 mm in diameter or 0.05 mL in volume. The drops were observed for 30 seconds from an approximate angle of 45°. If at least three of the five drops were not observed to wet or penetrate the fabric and did not show wicking around the drops, the test was repeated on an adjacent site using the test liquid having a rating of 2. The procedure was continued until at least three of the five drops wet or showed wicking into the fabric within 30 seconds. The fabric's AATCC oil repellency rating was determined to be the highest numbered liquid for which at least three of the five drops did not wet or wick into the fabric. Half point ratings may be given, for example 4.5 for a borderline pass on test liquid 5. An example of a borderline pass is where three or more of the five drops are rounded, however there is partial darkening of the specimen around the edge of the drop. In the United States, a commonly accepted level of oil repellency is a rating of 3.

The AATCC stain release rating was determined according to Standard Test Method 130-2000 of the American Association of Textile Chemists and Colorists (AATCC). Fabric samples were placed flat on new AATCC Textile Blotting Paper on a smooth, horizontal surface. Five drops (0.2 mL total) of Mazola® Corn Oil (available in most grocery stores) were placed on the fabric surface creating one single spot. A sheet of glassine paper was placed over the oil puddle, and a 2.27 kg (5 lb) weight was then placed directly over the glassine paper for 60 seconds. The weight and the glassine paper were removed, and the fabric sample was then washed for 12 minutes on normal wash cycle with high water level in a Kenmore® automatic using 100 grams of AATCC 1993 Standard Reference Detergent WOB. Wash temperature was 60° C., rinse temperature was cold. The total weight of the load was 4 lbs. After the final spin cycle, the entire load was placed in a Kenmore® automatic dryer and dried on high for 45-50 minutes.

Stain release ratings were determined by placing the stained, washed, and dried fabric flat in the center of a non-glare blacktop table with one edge of the table touching a Stain Release Replica (order number 08379, available from the AATCC). The fabric was viewed from a distance of approximately 76 cm (30 inches) and the residual stain was compared to the Stain Release Replica to the nearest 0.5 rating. Ratings are given from 1 (minimum) to 5 (maximum). In the United States, a commonly accepted level of stain release is a rating of 3.

The percent on weight of fabric for fluorine, represented as % owf_{F}, is determined as follows. Fluorine on the fabric, represented here as F_{FAB}, is measured by the well-known Wickbold torch method in parts per million (ppm). This value is then divided by the weight percent of fluorine in the fluorochemical, represented as F_{FC}, to obtain the fluorine percent on weight of fabric for that fluorochemical:
% owf_{F}=F_{FAB}/F_{FC}
When more than one fluorochemical is used, the total fluorine percent on weight of fabric is obtained by summing the individual fluorine percent on weight of fabric values for all fluorochemicals used.

### EXAMPLES

The following Examples demonstrate the present invention and its capability for use. The invention is capable of other and different embodiments, and its several details are capable of modifications in various apparent respects, without departing from the scope and spirit of the present invention. Accordingly, the Examples are to be regarded as illustrative in nature and not as restrictive.

Examples are numbered using a combination of the fluorochemical finish formulation number (1 through 6) and the fabric designation (A through E). For example, Example 1A refers to Fabric A which has been treated with the fluorochemical finish of Formulation 1.

In the following Examples, six formulations of fluorochemical finish were applied individually to samples of five polyester/cotton fabrics. The fluorochemical finishes were applied by padding wet on dry fabric, then drying to touch at 375° F. for one minute. The treated fabric samples were then washed following the ISO 15797:2002(E), Table 2, Condition 3 wash procedure with a modified wash temperature of 140° F. (60° C.). After 0, 1, 5, 10, 20, 30, 40, and 50 laundering cycles, fabric samples were evaluated for water repellency, oil (stain) repellency, and stain release according to the Water Drop Test Method, AATCC Test Method 118-2002, and AATCC Test Method 130-2000, respectively.

The compositions of the fluorochemical finishes used are given in Table 3. Knittex® 7636, a registered trademark of Ciba Specialty Chemicals, is an aqueous composition containing modified dimethyloldihydroxyethyleneurea (DMDHEU) and inorganic magnesium salt. Ultrasof® HDP, a registered trademark of Ciba Specialty Chemicals, is a high-density polyethylene emulsion. Ultratex® REP, a registered trademark of Ciba Specialty Chemicals, is an emulsion containing modified aminofunctional silicones. Zonyl® is a registered trademark of E.I. DuPont de Nemours and Company. Zonyl® 7713 is an aqueous dispersion (containing about 70 percent by weight of water) of a fluorinated polyurethane (about 7.5 percent by weight), a polyisocyanate in which the isocyanate groups are blocked by a ketonoxime (about 4 percent by weight), a mixture of polyesters based on adipic acid and alcohol with perfluoroalkyl radicals (about 11 percent by weight), propanediol (about 3 percent by weight), ethoxylated isotridecyl alcohol (about 2 percent by weight), with less than one percent by weight of hydrochloric and methanesulfonic acids. Zonyl® 7910 is an aqueous dispersion which contains about 30 to about 35 percent by weight of a fluorinated substituted urethane. In the formulations, the ratio of the percent on weight of fabric (% owf) of the fluorinated polyurethane to the percent on weight of fabric of the fluorinated substituted urethane was 0.7. In general, the ratio of the percent on weight of fabric of the at least one fluorinated polyurethane to the percent on weight of fabric of the at least one fluorinated substituted urethane in the fluorochemical finish may be from about 0.2 to about 3.0, for example from about 0.6 to about 1.4, or from about 0.8 to about 1.2.

TABLE 3
Fluorochemical Finish Compositions in grams/liter (g/l).

| Product Name | 1 | 2 | 3 | 4 | 5 | 6 |
|---|---|---|---|---|---|---|
| Knittex ® 7636 | 100 | 100 | 100 | 100 | 100 | 100 |
| Ultrasof ® HDP | 20 | 20 | 20 | 20 | 20 | 20 |
| Ultratex ® REP | 20 | 20 | 20 | 20 | 20 | 20 |
| Zonyl ® 7713 | 33 | 50 | 67 | 83 | 100 | 117 |
| Zonyl ® 7910 | 46 | 70 | 93 | 116 | 140 | 163 |

Five polyester/cotton blend fabrics were used in the testing. Fabrics A, B, and C were shirting fabrics of plain weave construction. Fabrics D and E were bottomweight 3×1 twills. Fabric A used Type 400™ brand polyester bicomponent fiber comprising poly(ethylene terephthalate) and poly(trimethylene terephthalate), commercially available from Invista S. à r. I. Type 400™ brand polyester bicomponent fiber comprising poly(ethylene terephthalate) and poly(trimethylene terephthalate) is also referred to herein as T-400™ brand polyester bicomponent fiber, or simply as T-400™. T-400™ can have an after heat-set crimp contraction value of from about 10% to about 80%, for example of from about 35% to about 80%.

For all fabrics, both of the yarns used in the warp were produced using Dacron® T-90S staple polyester fiber available from DAK America LLC. Two commercially available merges were used, 0.9 denier per fiber (dpf) Merge 177EHU and 1.2 dpf Merge 623E99. The T-90S fiber was intimately blended with cotton in a 65/35 T-90S/cotton ratio and then processed using conventional cotton systems processes (including carding, drawing, roving, and ring spinning) to manufacture 20 cc and 40 cc yarns. Merge 177EHU was used for the 40 cc and Merge 623E99 was used for the 20 cc yarns. The yarns were sized before warping in the conventional manner.

All fabrics were woven on a Dornier rapier loom. After scouring, fabrics were treated by pulling through a KUSTERS 10-ton padder at 6 yd/min with a pad pressure of 3000 psi. The fabrics were then cured at 375° F. (190° C.) for one minute. Fabric details are summarized in the following Table. The linear density of the spun yarn is given in the notation “cc”, which means “cotton count,” also called the English cotton count. Cotton count is related to denier by the relationship cc=5315/denier, where the denier is the linear density as measured by the weight in grams of the spun yarn per 9000 meters.

TABLE 4
Details of Fabrics Used in the Examples.

| | | | | | | Treated | | |
|---|---|---|---|---|---|---|---|---|
| | | Warp | | Weft | Fabric | Fabric | | |
| | Warp | ends | Weft | picks | Weight¹ | Weight² | Weight % | Weight % |
| Fabric | Yarn | per inch | Yarn | per inch | (oz/yd²) | (oz/yd²) | Polyester⁴ | Cotton |
| A | 65/35 | 96 | 150d-68 | 50 | 3.930 | 4.387 | 78 | 22 |
| | 40 cc | | T- | | | | | |
| | poly/cotton | | 400 ™ | | | | | |
| B | 65/35 | 96 | 40 cc | 58 | 3.153 | 3.382 | 40 | 60 |
| | 40 cc | | cotton | | | | | |
| | poly/cotton | | | | | | | |
| C | 65/35 | 96 | 40 cc | 58 | 3.199 | 3.336 | 65 | 35 |
| | 40 cc | | 65/35 | | | | | |
| | poly/cotton | | poly/cotton | | | | | |
| D | 65/35 | 86 | 20 cc | 35 | n/a | 5.072 | 65 | 35 |
| | 20 cc | | 65/35 | | | | | |
| | poly/cotton | | poly/cotton | | | | | |
| E | 65/35 | 86 | 20 cc | 35 | n/a | 4.981 | 46 | 54 |
| | 20 cc | | cotton | | | | | |
| | poly/cotton | | | | | | | |

Notes:
¹Fabric weight is given after fabric finishing but before application of fluorochemical finish.
²Treated fabric weight is given after application of fluorochemical finish Composition #1.
3) “n/a” means not available.
⁴Fabric A contained 37 wt % T-400 ™ within the total weight percent polyester reported in the Table.

Examples 1A through 6A demonstrate the water repellency, AATCC oil repellency, and AATCC stain release ratings for samples of polyester-rich 65135 polyester/cotton shirting fabric (Fabric A) treated with the six formulations of fluorochemical finish. In the Table below, ratings are given for each characteristic after the indicated number of industrial launderings at 60° C. with chlorine bleach.

TABLE 5
Fabric Water Repellency, Oil Repellency, and Stain Release Ratings
After Given Number of Launderings for Fabric A Treated with
Fluorochemical Finish Formulations 1-6.

| | Fluoro- | | | | |
|---|---|---|---|---|---|
| | chemical | | | | |
| | Finish | | | | |
| Exam- | Formula- | After This | Water | Oil | Stain |
| ple | tion | Number of | Repellency | Repellency | Release |
| No. | No. | Launderings | Rating | Rating | Rating |
| 1A | 1 | 0 | 6 | 6 | 5 |
| | | 1 | 6 | 6 | 5 |
| | | 5 | 6 | 6 | 5 |
| | | 10 | 6 | 6 | 5 |
| | | 20 | 5 | 5 | 3.5 |
| | | 30 | 5 | 3 | 3 |
| | | 40 | 4 | 1 | 2 |
| | | 50 | 3 | 0 | 1 |
| 2A | 2 | 0 | 6 | 6 | 5 |
| | | 1 | 6 | 6 | 5 |
| | | 5 | 6 | 6 | 5 |
| | | 10 | 6 | 6 | 5 |
| | | 20 | 5 | 5 | 3.5 |
| | | 30 | 5 | 4 | 3.5 |
| | | 40 | 5 | 2 | 2 |
| | | 50 | 4 | 0 | 1 |
| 3A | 3 | 0 | 6 | 6 | 5 |
| | | 1 | 6 | 6 | 5 |
| | | 5 | 6 | 6 | 5 |
| | | 10 | 6 | 6 | 5 |
| | | 20 | 6 | 6 | 4 |
| | | 30 | 5 | 5 | 3.5 |
| | | 40 | 5 | 4 | 3 |
| | | 50 | 4 | 1 | 2.5 |
| 4A | 4 | 0 | 6 | 6 | 5 |
| | | 1 | 6 | 6 | 5 |
| | | 5 | 6 | 6 | 5 |
| | | 10 | 6 | 6 | 5 |
| | | 20 | 6 | 6 | 5 |
| | | 30 | 5 | 5 | 4 |
| | | 40 | 5 | 4 | 3.5 |
| | | 50 | 4 | 2 | 2.5 |
| 5A | 5 | 0 | 6 | 6 | 5 |
| | | 1 | 6 | 6 | 5 |
| | | 5 | 6 | 6 | 5 |
| | | 10 | 6 | 6 | 5 |
| | | 20 | 6 | 6 | 5 |
| | | 30 | 6 | 6 | 4 |
| | | 40 | 5 | 5 | 3.5 |
| | | 50 | 4.5 | 3 | 3 |
| 6A | 6 | 0 | 6 | 6 | 5 |
| | | 1 | 6 | 6 | 5 |
| | | 5 | 6 | 6 | 5 |
| | | 10 | 6 | 6 | 5 |
| | | 20 | 6 | 6 | 5 |
| | | 30 | 6 | 6 | 4.5 |
| | | 40 | 5 | 5 | 4 |
| | | 50 | 5 | 3 | 3.5 |

Examples 1B through 6B demonstrate the water repellency, AATCC oil repellency, and AATCC stain release ratings for samples of cotton-rich 65/35 polyester/cotton shirting fabric (Fabric B) treated with the six formulations of fluorochemical finish. In the Table below, ratings are given for each characteristic after the indicated number of industrial launderings at 60° C. with chlorine bleach.

TABLE 6
Fabric Water Repellency, Oil Repellency, and Stain Release Ratings
with Number of Launderings for Fabric B Treated with Fluorochemical
Finish Formulations 1-6.

| | Fluoro- | | | | |
|---|---|---|---|---|---|
| | chemical | | | | |
| | Finish | | | | |
| Exam- | Formul- | After This | Water | Oil | Stain |
| ple | ation | Number of | Repellency | Repellency | Release |
| No. | No. | Launderings | Rating | Rating | Rating |
| 1B | 1 | 0 | 6 | 6 | 5 |
| | | 1 | 6 | 6 | 5 |
| | | 5 | 6 | 6 | 5 |
| | | 10 | 5 | 5 | 5 |
| | | 20 | 5.5 | 3 | 4.5 |
| | | 30 | 4 | 1 | 4 |
| | | 40 | 3 | 0 | 3 |
| | | 50 | 3 | 0 | 3.5 |
| 2B | 2 | 0 | 6 | 6 | 5 |
| | | 1 | 6 | 6 | 5 |
| | | 5 | 6 | 6 | 5 |
| | | 10 | 5 | 6 | 5 |
| | | 20 | 5 | 5 | 4.5 |
| | | 30 | 5 | 3 | 4 |
| | | 40 | 3 | 1 | 3.5 |
| | | 50 | 3 | 0 | 3.5 |
| 3B | 3 | 0 | 6 | 6 | 5 |
| | | 1 | 6 | 6 | 5 |
| | | 5 | 6 | 6 | 5 |
| | | 10 | 6 | 6 | 5 |
| | | 20 | 5 | 5 | 5 |
| | | 30 | 5 | 3 | 4.5 |
| | | 40 | 4 | 2 | 3.5 |
| | | 50 | 3 | 0 | 3.5 |
| 4B | 4 | 0 | 6 | 6 | 5 |
| | | 1 | 6 | 6 | 5 |
| | | 5 | 6 | 6 | 5 |
| | | 10 | 6 | 6 | 5 |
| | | 20 | 5 | 6 | 5 |
| | | 30 | 5 | 4 | 5 |
| | | 40 | 4 | 2 | 4 |
| | | 50 | 3 | 0 | 3.5 |
| 5B | 5 | 0 | 6 | 6 | 5 |
| | | 1 | 6 | 6 | 5 |
| | | 5 | 6 | 6 | 5 |
| | | 10 | 6 | 6 | 5 |
| | | 20 | 5 | 6 | 5 |
| | | 30 | 5 | 5 | 5 |
| | | 40 | 5 | 4 | 5 |
| | | 50 | 3 | 1 | 3.5 |
| 6B | 6 | 0 | 6 | 6 | 5 |
| | | 1 | 6 | 6 | 5 |
| | | 5 | 6 | 6 | 5 |
| | | 10 | 6 | 6 | 5 |
| | | 20 | 6 | 6 | 5 |
| | | 30 | 5 | 6 | 5 |
| | | 40 | 5 | 5 | 5 |
| | | 50 | 4 | 2 | 3.5 |

Examples 1C through 6C demonstrate the water repellency, AATCC oil repellency, and AATCC stain release ratings for samples of 65/35 polyester/cotton shirting fabric C) treated with the six formulations of fluorochemical finish. In the below, ratings are given for each umber of industrial launderings at 60° C. with chlorine bleach.

TABLE 7
Fabric Water Repellency, Oil Repellency, and Stain Release Ratings
with Number of Launderings for Fabric C Treated with Fluorochemical
Finish Formulations 1-6.

| | Fluoro- | | | | |
|---|---|---|---|---|---|
| | chemical | | | | |
| Exam- | Finish | After This | Water | Oil | Stain |
| ple | Formula- | Number of | Repellency | Repellency | Release |
| No. | tion No. | Launderings | Rating | Rating | Rating |
| 1C | 1 | 0 | 6 | 6 | 5 |
| | | 1 | 6 | 6 | 5 |
| | | 5 | 6 | 6 | 5 |
| | | 10 | 6 | 6 | 5 |
| | | 20 | 5 | 4 | 4.5 |
| | | 30 | 4 | 2 | 4 |
| | | 40 | 3 | 0 | 3.5 |
| | | 50 | 3 | 0 | 3 |
| 2C | 2 | 0 | 6 | 6 | 5 |
| | | 1 | 6 | 6 | 3.5 |
| | | 5 | 6 | 6 | 5 |
| | | 10 | 6 | 6 | 5 |
| | | 20 | 5 | 5 | 4.5 |
| | | 30 | 5 | 3 | 4.5 |
| | | 40 | 4 | 1 | 3.5 |
| | | 50 | 3 | 0 | 3.5 |
| 3C | 3 | 0 | 6 | 6 | 5 |
| | | 1 | 6 | 6 | 3 |
| | | 5 | 6 | 6 | 5 |
| | | 10 | 6 | 6 | 5 |
| | | 20 | 5 | 6 | 5 |
| | | 30 | 5 | 4 | 4.5 |
| | | 40 | 4 | 2 | 3.5 |
| | | 50 | 3 | 0 | 4 |
| 4C | 4 | 0 | 6 | 6 | 5 |
| | | 1 | 6 | 6 | 5 |
| | | 5 | 6 | 6 | 5 |
| | | 10 | 6 | 6 | 5 |
| | | 20 | 5 | 6 | 5 |
| | | 30 | 5 | 5 | 5 |
| | | 40 | 4 | 3 | 4 |
| | | 50 | 3 | 0 | 4 |
| 5C | 5 | 0 | 6 | 6 | 5 |
| | | 1 | 6 | 6 | 5 |
| | | 5 | 6 | 6 | 5 |
| | | 10 | 6 | 6 | 5 |
| | | 20 | 5 | 6 | 5 |
| | | 30 | 5 | 5 | 5 |
| | | 40 | 5 | 4.5 | 4 |
| | | 50 | 3 | 1 | 4 |
| 6C | 6 | 0 | 6 | 6 | 5 |
| | | 1 | 6 | 6 | 5 |
| | | 5 | 6 | 6 | 5 |
| | | 10 | 6 | 6 | 5 |
| | | 20 | 5.5 | 6 | 5 |
| | | 30 | 5 | 6 | 5 |
| | | 40 | 5 | 5 | 4 |
| | | 50 | 4 | 2 | 4.5 |

Examples 1D through 6D demonstrate the water repellency, AATCC oil repellency, and AATCC stain release ratings for samples of 65/35 polyester/cotton bottomweight fabric (Fabric D) treated with the six formulations of fluorochemical finish. In the Table below, ratings are given for each characteristic after the indicated number of industrial launderings at 60° C. with chlorine bleach.

TABLE 8
Fabric Water Repellency, Oil Repellency, and Stain Release Ratings
with Number of Launderings for Fabric D Treated with Fluorochemical
Finish Formulations 1-6.

| | Fluoro- | | | | |
|---|---|---|---|---|---|
| | chemical | | | | |
| Exam- | Finish | After This | Water | Oil | Stain |
| ple | Formula- | Number of | Repellency | Repellency | Release |
| No. | tion No. | Launderings | Rating | Rating | Rating |
| 1D | 1 | 0 | 5.5 | 6 | 5 |
| | | 1 | 6 | 6 | 5 |
| | | 5 | 5 | 5 | 5 |
| | | 10 | 5 | 4 | 5 |
| | | 20 | 4 | 3.5 | 3.5 |
| | | 30 | 3 | 0 | 3.5 |
| | | 40 | 3 | 0 | 3.5 |
| | | 50 | 2 | 0 | 3 |
| 2D | 2 | 0 | 6 | 6 | 5 |
| | | 1 | 6 | 6 | 5 |
| | | 5 | 6 | 6 | 5 |
| | | 10 | 5 | 5 | 5 |
| | | 20 | 4 | 4.5 | 4.5 |
| | | 30 | 4 | 1 | 3.5 |
| | | 40 | 3 | 0 | 3.5 |
| | | 50 | 2 | 0 | 3 |
| 3D | 3 | 0 | 6 | 6 | 5 |
| | | 1 | 6 | 6 | 5 |
| | | 5 | 6 | 6 | 5 |
| | | 10 | 5 | 6 | 5 |
| | | 20 | 4 | 4.6 | 4.5 |
| | | 30 | 4 | 2 | 3.5 |
| | | 40 | 3 | 0 | 3.5 |
| | | 50 | 2 | 0 | 3 |
| 4D | 4 | 0 | 6 | 6 | 5 |
| | | 1 | 6 | 6 | 5 |
| | | 5 | 6 | 6 | 5 |
| | | 10 | 5 | 6 | 5 |
| | | 20 | 5 | 4.5 | 4.5 |
| | | 30 | 4 | 3 | 4 |
| | | 40 | 3 | 1 | 3.5 |
| | | 50 | 3 | 0 | 3.5 |
| 5D | 5 | 0 | 6 | 6 | 5 |
| | | 1 | 6 | 6 | 5 |
| | | 5 | 6 | 6 | 5 |
| | | 10 | 5.5 | 6 | 5 |
| | | 20 | 5 | 4.5 | 4.5 |
| | | 30 | 5 | 4 | 4.5 |
| | | 40 | 4 | 2 | 4 |
| | | 50 | 3 | 0 | 3.5 |
| 6D | 6 | 0 | 6 | 6 | 5 |
| | | 1 | 6 | 6 | 5 |
| | | 5 | 6 | 6 | 5 |
| | | 10 | 6 | 6 | 5 |
| | | 20 | 5 | 5 | 5 |
| | | 30 | 5 | 5 | 5 |
| | | 40 | 5 | 3 | 5 |
| | | 50 | 4 | 1 | 3.5 |

Examples 1E through 6E demonstrate the water repellency, AATCC oil repellency, and AATCC stain release ratings for samples of cotton-rich 65/35 polyester/cotton bottomweight fabric (Fabric E) treated with the six formulations of fluorochemical finish. In the Table below, ratings are given for each characteristic after the indicated number of industrial launderings at 60° C. with chlorine bleach.

TABLE 9
Fabric Water Repellency, Oil Repellency, and Stain Release Ratings
with Number of Launderings for Fabric E Treated with Fluorochemical
Finish Formulations 1-6.

| | Fluoro- | | | | |
|---|---|---|---|---|---|
| | chemical | | | | |
| Exam- | Finish | After This | Water | Oil | Stain |
| ple | Formula- | Number of | Repellency | Repellency | Release |
| No. | tion No. | Launderings | Rating | Rating | Rating |
| 1E | 1 | 0 | 6 | 6 | 5 |
| | | 1 | 6 | 6 | 5 |
| | | 5 | 5 | 5.5 | 5 |
| | | 10 | 5 | 5 | 5 |
| | | 20 | 4 | 2 | 4 |
| | | 30 | 3 | 0 | 3.5 |
| | | 40 | 3 | 0 | 3.5 |
| | | 50 | 2 | 0 | 2.5 |
| 2E | 2 | 0 | 6 | 6 | 5 |
| | | 1 | 6 | 6 | 5 |
| | | 5 | 5.5 | 6 | 5 |
| | | 10 | 5 | 5 | 5 |
| | | 20 | 5 | 3 | 4.5 |
| | | 30 | 3.5 | 1 | 4 |
| | | 40 | 4 | 0 | 3.5 |
| | | 50 | 3 | 0 | 3 |
| 3E | 3 | 0 | 6 | 6 | 5 |
| | | 1 | 6 | 6 | 5 |
| | | 5 | 6 | 6 | 5 |
| | | 10 | 5 | 6 | 5 |
| | | 20 | 5 | 4 | 5 |
| | | 30 | 4 | 2 | 4 |
| | | 40 | 4 | 0 | 3.5 |
| | | 50 | 3 | 0 | 3 |
| 4E | 4 | 0 | 6 | 6 | 5 |
| | | 1 | 6 | 6 | 5 |
| | | 5 | 6 | 6 | 5 |
| | | 10 | 6 | 6 | 5 |
| | | 20 | 5 | 5 | 5 |
| | | 30 | 4 | 3 | 4 |
| | | 40 | 4 | 1 | 3.5 |
| | | 50 | 3 | 0 | 3 |
| 5E | 5 | 0 | 6 | 6 | 5 |
| | | 1 | 6 | 6 | 5 |
| | | 5 | 6 | 6 | 5 |
| | | 10 | 6 | 6 | 5 |
| | | 20 | 5 | 5 | 5 |
| | | 30 | 5 | 4 | 5 |
| | | 40 | 4 | 2 | 5 |
| | | 50 | 3 | 0 | 3 |
| 6E | 6 | 0 | 6 | 6 | 5 |
| | | 1 | 6 | 6 | 5 |
| | | 5 | 6 | 6 | 5 |
| | | 10 | 6 | 6 | 5 |
| | | 20 | 5 | 6 | 5 |
| | | 30 | 5 | 4 | 5 |
| | | 40 | 5 | 3 | 5 |
| | | 50 | 3 | 0 | 3 |

For the results presented in the above Tables, the fluorochemical finish was considered to provide adequate oil repellency, water repellency, and stain release—that is, to be durable after repeated industrial laundering—when the rating for each characteristic was at least 3. Results for Fabric A showed that all six formulations were durable through at least five, as well as at least 30, industrial launderings at 60° C. Four of the formulations (Formulations 3-6) were durable through at least 40 industrial launderings, and Formulations 5 and 6 were both durable through at least 50 industrial launderings of the fabric.

In the case of Fabric B, all six formulations were durable through at least five, as well as at least 20, industrial launderings. Five of the formulations (Formulations 2-6) were durable through at least 30 industrial launderings, and Formulations 5 and 6 were both durable through at least 40 industrial launderings.

For Fabric C, the results showed that all six formulations were durable through at least five, as well as at least 20, industrial launderings. Five formulations (Formulations 2-6) were durable through at least 30 industrial launderings, and Formulations 4-6 were durable through at least 40 industrial launderings.

Results for Fabric D indicated that all six formulations were durable through at least five, as well as at least 20, industrial launderings, three formulations (Formulations 4-6) were durable through at least 30 industrial launderings, and Formulation 6 was durable through at least 40 industrial launderings.

For Fabric E, all six formulations were durable through at least five, as well as at least 10, industrial launderings, and five formulations (Formulations 2-6) were durable through at least 20 industrial launderings. Three formulations (Formulations 4-6) were durable through at least 30 industrial launderings, and Formulation 6 was durable through at least 40 industrial launderings.

For all the fabrics tested, results showed that Formulation 1 was the least durable and that Formulation 6 was the most durable to repeated industrial laundering at 60° C.

Many modifications and other embodiments of the inventions set forth herein will come to mind to one skilled in the art to which these inventions pertain having the benefit of the teachings presented in the foregoing descriptions. Therefore, it is to be understood that the inventions are not to be limited to the specific embodiments disclosed and that modifications and other embodiments are intended to be included within the scope of the appended claims.

What is claimed is:

1. A fabric comprising one or more polyesters or one or more polyesters blended with other fibers or combinations of fibers, wherein the fabric is treated with a finish comprising at least one fluorochemical stain repellent agent and at least one fluorochemical stain release agent, wherein the fabric has an oil repellency rating of at least 3 as measured by AATCC Test Method 118-2002 and a stain release rating of at least 3 as measured by AATCC Test Method 130-2000 after at least 5 industrial launderings at about 55° C. to about 65° C.

2. The fabric of claim 1 wherein the fabric further has a water repellency rating of at least 3 as measured by the Water Drop Test Method.

3. The fabric of claim 1 wherein the fabric further has said oil repellency and said stain release ratings after at least 30 industrial launderings.

4. The fabric of claim 1 wherein the fabric has said oil repellency and said stain release ratings after at least 50 industrial launderings.

5. The fabric of claim 1 comprising a blend with cotton, wherein the fabric comprises from about 5 weight percent to about 95 weight percent polyester, based on total weight of fabric.

6. The fabric of claim 5, wherein the polyester is a bicomponent fiber comprising poly(trimethylene terephthalate) and at least one polymer selected from the group consisting of poly(ethylene terephthalate), poly(trimethylene terephthalate), and poly(tetramethylene terephthalate), or a combination of such members.

7. The treated fabric of claim 6, wherein the bicomponent fiber comprises a combination of poly(ethylene terephthalate) and poly(trimethylene terephthalate).

8. The fabric of claim 1, wherein the at least one fluorochemical stain repellent agent comprises at least one fluorinated polyurethane, and the at least one fluorochemical stain release agent comprises at least one fluorinated substituted urethane.

9. The fabric of claim 8 wherein the ratio of the percent on weight of fabric of the at least one fluorinated polyurethane to the percent on weight of fabric of the at least one fluorinated substituted urethane is from about 0.2 to about 3.0.

10. The fabric of claim 9, wherein the ratio of the percent on weight of fabric of the at least one fluorinated polyurethane to the percent on weight of fabric of the at least one fluorinated substituted urethane is from about 0.6 to about 1.4.

11. A textile article comprising the fabric of claim 1.

12. The textile article of claim 11 wherein the textile article is selected from the group consisting of a uniform, a jumpsuit, a smock, a work shirt, a work pant, a chef coat, a chef apron, and a chef hat, or a combination of such articles.

13. A method for treating a fabric with a finish to impart oil repellency, water repellency, and stain release which is durable to repeated industrial laundering, the method comprising the steps of:
a) providing a fabric comprising one or more polyesters or one or more polyesters blended with another fiber or combination of fibers;
b) applying a finish comprising at least one fluorinated polyurethane stain repellent agent and at least one fluorinated substituted urethane stain release agent, wherein the ratio of the percent on weight of fabric of the at least one fluorinated polyurethane to the percent on weight of fabric of the at least one fluorinated substituted urethane is from about 0.2 to about 3.0; and
c) drying the fabric with applied finish from about 160° C. to about 200° C.

14. The method of claim 13, wherein the fabric comprises polyester and cotton, and the fabric comprises from about 5 weight percent to about 95 weight percent polyester, based on total weight of fabric.

15. The method of claim 14, wherein the polyester is a bicomponent fiber comprising poly(trimethylene terephthalate) and at least one polymer selected from the group consisting of poly(ethylene terephthalate), poly(trimethylene terephthalate), poly(tetramethylene terephthalate), and a combination of such members.

16. The method of claim 15, wherein the bicomponent fiber comprises poly(ethylene terephthalate) and poly(trimethylene terephthalate).

17. The method of claim 13, wherein the method of applying the finish is selected from the group consisting of padding, coating, impregnating, immersing, spraying, brushing, film-coating, and a combination of such application methods.

18. The method of claim 13, wherein the fabric with applied finish is dried for about 1 minute to about 2 minutes.

19. The method of claim 13, wherein the ratio of the percent on weight of fabric of the at least one fluorinated polyurethane stain repellent agent to the percent on weight of fabric of the at least one fluorinated substituted urethane stain release agent is from about 0.6 to about 1.4.

20. A method for industrial laundering of a fabric or a textile article comprising the fabric, the fabric being treated with a finish comprising at least one fluorochemical stain repellent agent and at least one fluorochemical stain release agent to impart oil repellency and stain release, the method comprising the steps of:
a) providing a treated fabric or a textile article comprising the treated fabric,
b) washing the fabric or the textile article in water containing a detergent at about 55° C. to about 65° C.;
c) separating the wash water from the fabric or textile article;
d) rinsing the fabric or the textile article;
e) separating the rinse water from the fabric or textile article; and
f) drying the fabric or textile article to provide dry fabric or dry textile article having an oil repellency rating of at least 3 as measured by AATCC Test Method 118-2002 and a stain release rating of at least 3 as measured by AATCC Test Method 130-2000.

21. The method of claim 21, wherein the finish comprises at least one fluorinated urethane polymer as the stain repellent agent and at least one perfluorinated polymer as the stain release agent.

22. The method of claim 21, wherein the water for washing contains chlorine bleach.

23. The method of claim 20 wherein the fabric or the textile article has said oil repellency and said stain release ratings of at least 3 after repeating steps a) through f) at least 5 times.

24. The method of claim 20, wherein the fabric or the textile article has said oil repellency and said stain release ratings after repeating steps a) through f) above at least 30 times.

25. The method of claim 20, wherein the fabric or textile article has said oil repellency and said stain release ratings after repeating steps a) through f) at least 40 times.

26. The method of claim 20, wherein the fabric or textile article has said oil repellency and said stain release ratings after repeating steps a) through f) at least 50 times.
